(19) United States
(12) Patent Application Publication
(10) Pub. No.: US 2009/0024663 A1
(43) Pub. Date: Jan. 22, 2009

(54) Techniques for Information Security Assessment

(76) Inventor: Mark D. McGovern, Toms River, NJ (US)

Correspondence Address: GOODWIN PROCTER LLP, 901 NEW YORK AVENUE, N.W., WASHINGTON, DC, 20001, US

(21) Appl. No.: 12/177,126

(22) Filed: Jul. 21, 2008

Related U.S. Application Data
(60) Provisional application No. 60/950,684, filed on Jul. 19, 2007.

(51) Int. Cl. G06F 21/00; G06F 17/30

(52) U.S. Cl. 707/104.1; 726/25; 707/E17.044

(57) ABSTRACT

Methods for information security assessment and data risk scoring are disclosed. A disclosed method includes identifying a plurality of parameters relevant to information security of information systems, establishing at least two risk levels associated with each of the plurality of parameters, assigning a numerical score to each of the at least two risk level associated with each of the plurality of parameters, recording the parameters, risk levels and numerical scores into one or more data structures, and assessing and scoring information security of a specified information system and/or collectively for an entire enterprise based at least in part on the one or more data structures.

### CROSS-REFERENCE

This application claims priority to Provisional Application Ser. No. 60/950,684 filed Jul. 19, 2007, the entirety of which is hereby incorporated by reference.

### TECHNICAL FIELD

The disclosed embodiments relate generally to information technology and data security. More particularly, the disclosed embodiments relate to information security assessment and data risk scoring.

### BACKGROUND

Information security is the process of protecting information and information systems from unauthorized access, use, disclosure, disruption, modification, or destruction. Information systems may include individual computing devices, such as personal computers, work stations, and mobile devices, or, more typically, a group of interconnected computing and communications equipment. The information to be protected can be any type of data records, such as personal or financial data concerning individuals, customer data or trade secrets possessed by companies, valuable or sensitive commercial intelligence, governmental or political secrets, or other intellectual assets. The purpose of information security is to safeguard the integrity, confidentiality, and availability of protected information by preventing improper information modification or destruction, ensuring information non-repudiation and authenticity, preserving authorized restrictions on access and disclosure, protecting personal privacy and proprietary information, and providing timely and reliable access to and use of information.

As computer and communications networks see more widespread uses in both business and personal lives, information security problems have also become more prevalent. For example, several incidents have been reported in recent years where companies lost a large amount of employee or consumer data due to hacker attacks and stolen or misplaced storage media. Several e-commerce websites were at one time or another crippled by denial of service (DOS) attacks and suffered significant economic losses. Enterprise electronic mail servers may become paralyzed by malicious attacks of worms or viruses. Personal computers or home networks are often compromised by spy-ware and ad-ware. Information security risks are practically everywhere and can materialize at any time. Failure to recognize the risks and take appropriate action can have grave consequences.

However, existing security risk assessment and remediation approaches are often inadequate or inefficient. While many information security vulnerabilities are interrelated and cannot be addressed in isolation, very few existing approaches, if any, can take a holistic view of an information system to provide an all-inclusive diagnosis. Many information technology (IT) experts and consulting firms are only capable of assessing and mitigating security risks in a piecemeal or ad hoc fashion. For example, an information security administrator typically responds to security breaches by patching up corresponding vulnerabilities in an information system. Security consultants typically specialize in discrete aspects of IT infrastructures but cannot provide a comprehensive security assessment that encompasses all key aspects of an information system.

While there have been efforts to make a security assessment of the IT infrastructure of an entire enterprise, such assessment often has to be customized for the particular information system in question, and the investigation and analysis involved can be quite costly and time-consuming. So far, the field lacks an efficient, systematic approach for information security assessment that can be readily adapted to and implemented for any given information system. In addition, there is a lack of a common set of security parameters or an authoritative benchmark for comparing one organization's risk exposure to that of another. As a result, it has been difficult for regulatory bodies to evaluate information systems of different companies and government agencies. Without an effective framework or a common benchmark, government regulators cannot efficiently and objectively determine whether an organization has complied with regulatory or statutory requirements for data privacy and network security. Nor can an organization itself be reasonably certain whether it is in compliance or, if not, what remediation measures to take.

In view of the foregoing, it may be understood that there are significant problems and shortcomings associated with current information security assessment technologies.

### SUMMARY

Methods for information security assessment are disclosed. In one particular aspect, a computer-implemented method for information security and data risk assessment is disclosed. In one embodiment, the method includes identifying a plurality of security parameters corresponding to security aspects of the information security of an information system, establishing at least two risk levels associated with each of the plurality of security parameters, assigning a component score to each of the at least two risk levels associated with each of the plurality of security parameters, storing the security parameters, risk levels and component scores in a memory according to one or more data structures, the data structures corresponding to an industry security standard, and calculating a composite score based on the security parameters, risk levels and numerical scores, the composite score indicating the overall security risk exposure of the information system according to the industry security standard.

In another aspect, a computer-implemented method of employing a numerical scoring scheme in an information security assessment is disclosed. In one embodiment, the method includes collecting input data descriptive of Information Systems for an organization, matching the input data with a plurality of security parameters in a scoring data structure corresponding to a regulatory standard, determining, for each security parameter and based on the input data, a component score by assessing a risk level corresponding to each said security parameter, thereby establishing a plurality of component scores, and synthesizing the plurality of component scores to generate a composite score indicative of an overall data security risk exposure of the IT infrastructure or sector scores indicative of security risks in portions or aspects of the IT infrastructure. In another embodiment, the method may also include the issuing an assessment report, a security certificate, and/or an opinion letter based at least in part on the assessment and scoring of the IT infrastructure of the organization. In yet another embodiment, the method may further include identifying one or more security weaknesses in the IT infrastructure and proposing remediation options based on the assessment and scoring of the IT infrastructure of the organization.

In another aspect, a system for employing a numerical scoring scheme in an information security assessment is disclosed. In one embodiment, the system includes a memory storing input data descriptive of an IT infrastructure of an organization, and a processor configured to match the input data with a plurality of security parameters in a scoring data structure, determine, for each security parameter and based on the input data, a component score by assessing a risk level corresponding to said each security parameter, thereby establishing a plurality of component scores, and synthesize the plurality of component scores to generate a composite score indicative of an overall security risk exposure of the IT infrastructure or sector scores indicative of security risks in portions or aspects of the IT infrastructure.

Various embodiments will now be described in more detail with reference to examples thereof as shown in the accompanying figures. While the disclosed embodiments are described below with reference to examples, it should be understood that the claimed embodiments are not limited thereto. Those of ordinary skill in the art having access to the teachings herein will recognize additional implementations, modifications, and embodiments, as well as other fields of use, which are within the scope of the claimed embodiments as described herein, and with respect to which the claimed embodiments may be of significant utility.

### BRIEF DESCRIPTION OF THE FIGURES

To facilitate a fuller understanding of the disclosed embodiments, reference is now made to the accompanying figures. These figures should not be construed as limiting, but are intended to be exemplary only.

FIG. 1 illustrates an exemplary information system of an organization for which the disclosed methods for information security assessment may be implemented in accordance with various disclosed embodiments;

FIG. 2 illustrates a flow chart illustrating an exemplary method for information security assessment in accordance with a disclosed embodiment;

FIG. 3 illustrates a flow chart illustrating an exemplary method for information security assessment in accordance with a disclosed embodiment;

FIG. 4 illustrates a block diagram illustrating an exemplary scoring data structure for information security assessment in accordance with a disclosed embodiment; and

FIG. 5 illustrates a block diagram illustrating an exemplary method for information security assessment in accordance with a disclosed embodiment.

### DETAILED DESCRIPTION

Disclosed embodiments provide techniques for assessing and scoring security risks of information systems. As used herein, an “information system” typically refers to a system of persons, computing and/or communications equipment, data records, and activities that process the data and information in a given organization. An information system may include or may be a computer-based information system. However, an information system may encompass not only computing software and hardware, but also human activities, processes, methods, and/or policies related to the access to and use of information (as well as the information system hosting such information). In addition, an information system may be of any size and may be private or public. For example, although disclosed embodiments are particularly useful for assessing information security of large enterprise networks, and embodiments are described below in that context, an information system may be as small as a single computer, whether networked or standing alone.

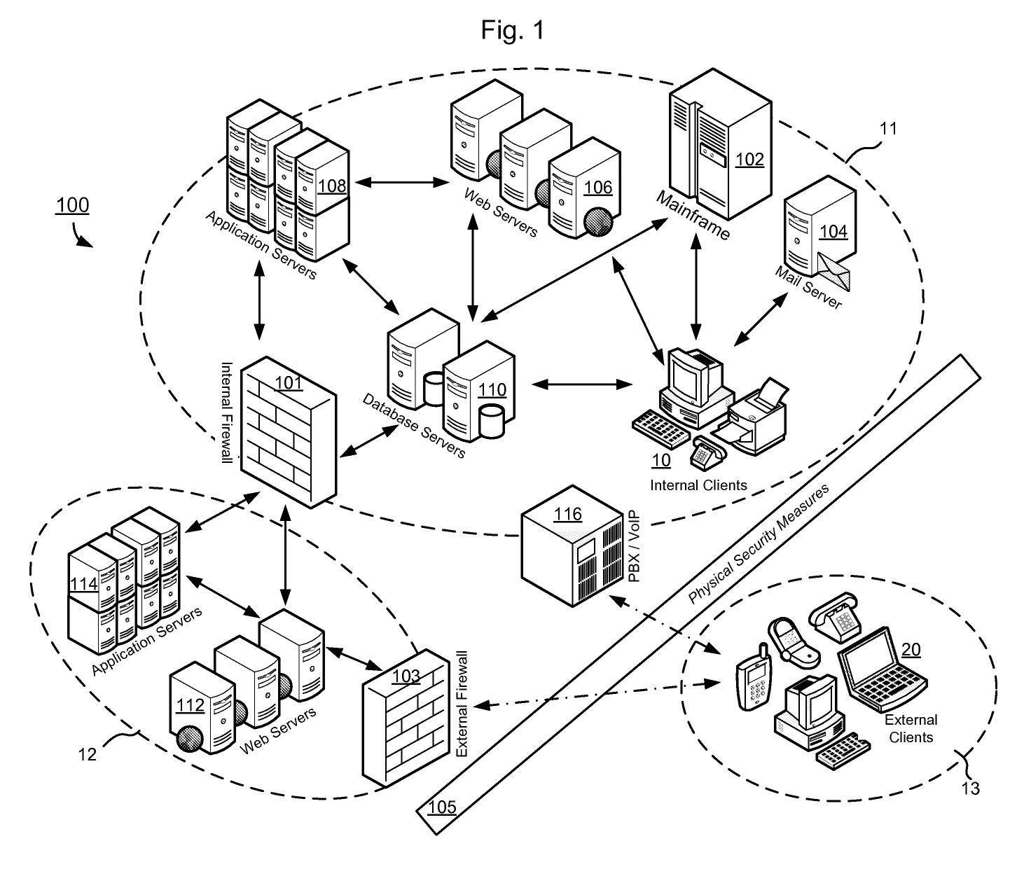

Referring to FIG. 1, there is illustrated an exemplary information system 100 of an organization for which the techniques for information security assessment may be implemented in accordance with various disclosed embodiments. The organization owner/operator of the information system 100 may be either a private entity (e.g., a company, a university, or an airport) or a government entity (e.g., a court, an agency, or a military unit).

The information system 100 may have a fairly expansive IT infrastructure that is accessible by both internal clients 10 and external clients 20. The IT infrastructure may be divided into three security zones: a backend zone 11, a perimeter zone 12, and an Internet zone 13. The backend zone 11 and the perimeter zone 12 may be separated by an internal firewall 101, and the perimeter zone 12 and the Internet zone 13 may be separated by an external firewall 103. The information system 100 may also implement physical security measures 105 to control physical access to the IT infrastructure.

The backend zone 11 may comprise a wide array of computing equipment, such as a mainframe computer 102, a mail server 104, web servers 106, application servers 108, and database servers 110. These computing equipment may be interconnected with one another via one or more local area networks (LANs) and/or wide area networks (WANs). That is, the backend zone 11 of the information system 100 is not necessarily concentrated in a single geographic location, but may be spread out across one or more states, countries, or continents. For example, the organization may be a multi-national corporation with networks of its global offices interweaved into a virtual private network (VPN). The backend zone 11 may host the most sensitive and important data, processes, and functions of the organization. The internal clients 10 may include personnel of the organization such as employee users and network administrators. From the perspective of the internal clients 10, the backend zone 11 may represent the most trusted network resources. Less stringent security measures may be needed for interactions among those computing equipment in the backend zone 11 except for the portion of network traffic that might be carried on public networks. In order to securely exchange information over public networks, the information system 100 may implement a suite of security measures (known as “trust management”), for example, to encrypt information according to its confidentiality level and to generate and distribute encryption keys.

The perimeter zone 12 may comprise web servers 112 and application servers 114 which host applications for the organization's Web presence and information sites that may not perform critical transactions or provide complex services. The perimeter zone 12 may be a semi-trusted zone that is still logically within the organization but does not host business-critical data or services. The external clients 20 are allowed to access the information system 100 through the external firewall 103 which forms the organization's first line of defense. Communications between the perimeter zone 12 and the backend zone 11 may be filtered by the internal firewall 101, which forms a second line of defense. The internal clients 10 may also communicate among themselves or with the external clients 20 via a private branch exchange (PBX) or a Voice-over-IP (VoIP) server 116.

Network ingress and egress nodes, such as the firewalls 101 and 103 or the PBX/VoIP server 116, may be particularly vulnerable to hacker attacks or other security breaches. Potential intruders may exploit security weaknesses in the firewall proxy servers, such as software backdoors or security policy loopholes, to gain unauthorized access to the information system 100. As a countermeasure, the information system 100 may need to perform vulnerability management to uncover and remedy security weaknesses as early as possible. Vulnerability management may involve careful system maintenance such as receiving vulnerability updates and applying security patches to software and firmware components in the information system 100. Vulnerability management may also involve the use of software tools for security scanning and vulnerability removal.

The information system 100 may also need threat management and disaster recovery capabilities in case intruders do succeed in gaining access or causing damages. Threat management may involve a detection mechanism (e.g., real-time virus monitoring) to provide early warnings of security threats in progress. Threat management may also involve a defense mechanism to thwart an attempted breach or to stop a breach from progressing further. Where the information system 100 has suffered damages from a recent security breach, a well-maintained and updated disaster recovery plan can help mitigate the damages and quickly restore the information system 100 to its normal operations.

The Internet zone 13 may include the external clients 20 who use Web application services hosted by the perimeter zone 12 and/or the backend zone 11 of the information system 100. The external clients 20 may include employees as well as customers of the organization. Apart from legitimate users, there may also be hackers or other unwelcome characters who may attempt to gain unauthorized access to the information system 100. As a result, the information system 100 may implement identity and access management (I&AM) at various access gateways such as the external firewall 103 and the internal firewall 101. The authentication of external clients 20 may be more than the establishment of user IDs and passwords. The access control may also be affected by the implementation of access policies, enforcement of user roles and entitlements, strength of encryption algorithms, and even the availability and quality of directory services. The purpose of I&AM measures is not limited to blocking unauthorized intruders, but also to give each authorized user the appropriate type and scope of access to the information system 100. Accordingly, the firewalls (101 and 103) and the PBX/VoIP server 116 may authenticate and authorize users based on the proper security context and individual preferences and may perform policy-based routing of user requests.

The description of the information system 100 above is intended to show the complexity of information security assessment due to the interrelatedness of a plurality of factors that might have an impact. The description above also identifies some of the key aspects of an IT infrastructure that are particularly important for information security, namely, identity management, vulnerability management, threat management, trust management, and disaster recovery (or “continuity of business”) plans. The multifaceted-ness of information security assessment is not unique to a large enterprise network. Rather, even single computers and small home networks are affected by a multitude of security factors. Therefore, the exemplary security assessment methods described below may be applicable to all kinds of information systems regardless of size or scale.

Additionally, the various disclosed embodiments may be implemented on a computer or computers such as the clients or servers illustrated in the information system 100. In one embodiment, the method is implemented on a computer or computers that are a part of the IT system being assessed. Alternatively, the method may be implemented using a computer or computers distinct from those in the system being audited.

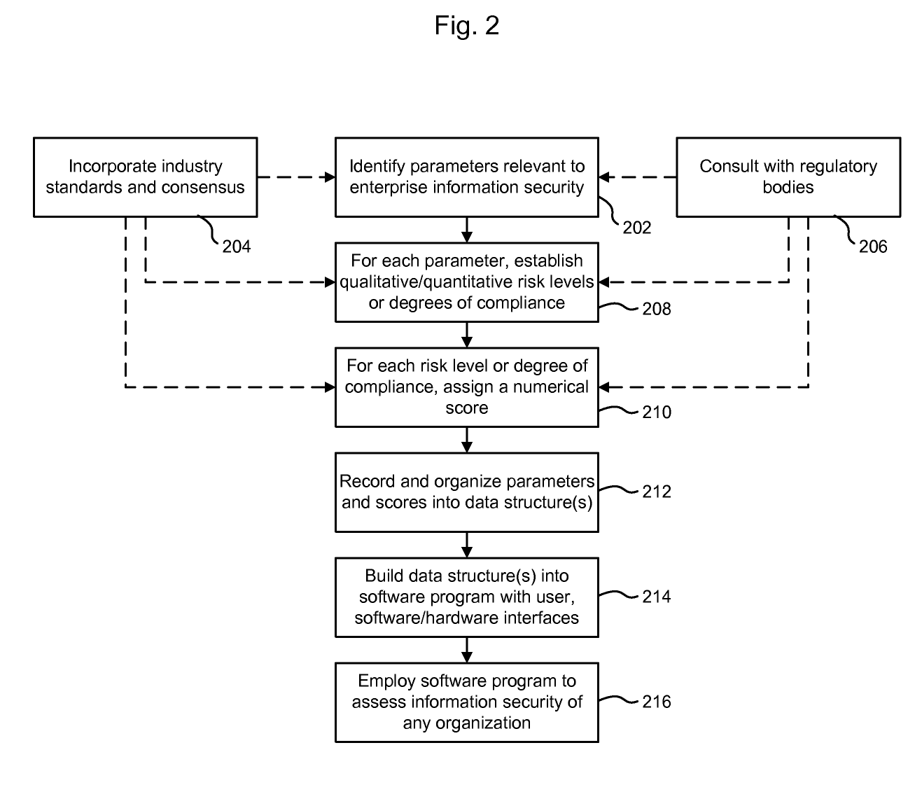

FIG. 2 illustrates a flow chart illustrating an exemplary method for information security assessment in accordance with a disclosed embodiment.

In step 202, parameters relevant to enterprise information security may be identified. The parameters may be referred to as “security parameters” and may relate to a plurality of aspects of an information system. Most typically, the security parameters may encompass the key aspects of information security as described above, such as identity management, vulnerability management, threat management, trust management, and disaster recovery plans. However, the security parameters may also reflect the basics of an information system, such as hardware and software configuration, network size and scale, which may also have an impact on security risks.

According to one embodiment, at least a portion of the relevant set of security parameters may be identified, in step 204, based on industry standards and/or consensus. For example, the security parameters may be selected based on well-known Internet standards or proposed standards (e.g., “request for comments” or RFCs) as published by the Internet Engineering Task Force (IETF). One example may be RFC4301—“Security Architecture for the Internet Protocol” (IPsec) and the related documents in the IPsec protocol suite, which describe various topics such as IP Authentication Header, IP Encapsulating Security Payload (ESP), Cryptographic Algorithms, Internet Key Exchange (IKE), Security Associations, and Security Policy Databases. Security parameters identified in the Internet standards or proposed standards may be incorporated into the parameter set for security assessment purposes. However, the standards or protocols are not the only source of security parameters. The parameter set may also reflect consensus of the Internet community or IT communities and may include such security parameters as commonly recognized as “best practices.” According to some embodiments, the information security assessment techniques may be configured for particular industries or industry sectors, such as consumer banks, credit card companies, insurance providers, hospitals or clinics, online vendors, and so on. In that case, the parameter set may include industry- or sector-specific security parameters.

According to another embodiment, some or all of the relevant security parameters may be established by consulting with regulatory bodies in step 206. One or more agencies or commissions on the state or federal level may be charged with enforcing regulatory or statutory standards of data privacy and network security. Exemplary regulatory bodies may include Federal Deposit Insurance Corporation (FDIC), Securities and Exchange Commission (SEC), Office of the Comptroller of the Currency (OCC), the Federal Financial Institutions Examination Council (FFIEC), and state banking commissions. The various regulatory bodies promulgate and enforce security standards including, but not limited to, Financial & Regulatory Compliance standards (e.g., Uniform Rating System for Information Technology (URSIT), Uniform Financial Institution Rating System (UFIRS), FFIEC Audit Framework for Information Security and for Risk Analysis, California SB 1386 (Identity Theft), Bank Secrecy Act (BSA), PCI Data Security Standard, Authentication Assessment, Sarbanes Oxley Act, Gramm Leach Bliley Act (GLBA), FTC Red Flag, FACTA 2003), Information Security/ISO 17799 standards (e.g., FFIEC Audit Framework for Information Security, ISO/IEC 17799:2005, ISO/IEC 27001, COBIT 4), Physical Security standards (e.g., Army Field Manual Best Practices, FEMA 426—Protecting Buildings Against Terrorism, Customs Trade Partnership Again Terrorism (C-TPAT), ASIS Threat Guidelines), Federal Information Systems standards (e.g., NIST 800-53, NIST 800-53, NIST 800-53A), and Medical Information standards (e.g., Health Insurance Portability and Accountability Act (HIPAA)).

For example, the FFIEC Information Technology Examination Handbooks provide detailed guidance regarding the various requirements and criteria relating to information security in the financial services context. These handbooks include multiple booklets and related workprograms, each of which are incorporated herein in their entireties, for the various topics including Audit (Audit Booklet—August 2003; workprogram of September 2003), Business Continuity Planning (Business Continuity Planning Booklet—March 2008; workprogram of December 2007), Development and Acquisition (Development and Acquisition Booklet—April 2004; workprogram of April 2004), E-Banking (E-Banking Booklet—August 2003; workprogram of August 2003), FedLine (FedLine Booklet—August 2003; workprogram of September 2003), Information Security (Information Security—July 2006; workprogram of July 2006), Management (Management—June 2004; workprogram of June 2004), Operations (Operations Booklet—July 2004; workprogram of July 2004), Outsourcing Technology Services (Outsourcing Technology Services Booklet—June 2004; workprogram of June 2004), Retail Payment Systems (Retail Payment Systems—March 2004; workprogram of March 2004), Supervision of Technology Service Providers (Supervision of Technology Service Providers Booklet—March 2003; workprogram of March 2003), and Wholesale Payment Systems (Wholesale Payment Systems Booklet—July 2004; workprogram of July 2004). Similarly, organizations such as NIST and ISO publish detailed standards relating to information security which can also provide an audit framework compatible with the various disclosed embodiments. Further, agency regulations and statutes themselves, including, but not limited to HIPAA and the FTC's “Red Flag” identity theft requirements, can also provide a suitable audit framework. Moreover, best practices developed in the industry by private parties or organizations relating to compliance with such regulations and statutes are also suitable for use with the disclosed embodiments.

The disclosed embodiments are adaptable to allow for accurate assessment according to one or more of these regulations and statutes. In particular, where the relevant regulations and statutes clearly specify security requirements of information systems, such requirements may be directly incorporated into the parameter set for security assessment purposes.

Consultation with the regulators may advantageously clarify the regulatory and statutory standards, identify the most relevant security parameters, and increase the chance of regulatory approval based on the ultimate assessment results. Such consultation with regulators may be particularly beneficial for establishing industry- or sector-specific security parameters, and especially for those heavily regulated industries (e.g., banking and healthcare) where companies expect to be audited for security compliance. Further, the regulators may optionally provide detailed templates or worksheets which outline the various security requirements of the promulgated regulations or statutes.

Once a relevant set of security parameters have been identified, then, in step 208, two or more risk levels or degrees of compliance may be established for each security parameter. The risk levels or degrees of compliance may qualitatively and/or quantitatively describe what is in place in an information system with respect to the corresponding security parameter. The risk levels or degrees of compliance may be binary (i.e., 0 vs. 1, risk vs. no risk, compliant vs. non-compliant) or may have more than two values.

For example, in the identity management area, one security parameter may indicate how often a network user is required to change his or her login password. The risk level is at the highest if users are never required to change login password. The risk level is lower if users are forced to change passwords every 90 days. The risk level is even lower if the frequency of forced password change increases to every 30 days. Other access control mechanisms, such as security tokens and biometrics may further lower the risk level. Therefore, another security parameter may reflect the presence or absence of a security token or biometrics requirement in addition to regular username and password. Yet another exemplary security parameter may be the encryption strength requirement of Web servers in an information system. For example, the Web servers may require a minimum session-key length for all Secure Sockets Layer (SSL) communications, and such session-key length may be used as a quantitative indication of risks in secure web sessions—the longer the session keys, the lower the associated risk level. As can be appreciated by those skilled in the art of information security, there are many other security parameters and, for each security parameter, there may be more than one ways of defining the potential risk levels or degrees of compliance.

In step 210, for each risk level or degrees of compliance (associated with each security parameter), a numerical score may be assigned. One purpose of the numerical score assignment is to quantify the contribution of each security parameter to ultimately reach an overall risk assessment. According to one embodiment, the numerical scores may be set up so that a higher score reflects a greater risk exposure. This exposure can be determined by the evaluation of underlying assets, including goodwill and negative publicity. For example, in the commercial banking context, an embodiment of the method can accommodate consideration of the value of underlying assets to varying degrees depending on, for example, the ratio of the assets-at-risk to the total FDIC insured balances, a Basel capital requirement, or another recommended or required capital requirement. Alternatively, the numerical scores may correlate with degrees of compliance with security standards, with a higher score indicating a better, more compliant security practice (i.e., smaller risk exposure).

The numerical scores for the security parameters may take any form. For example, the scores may be positive integers or fractions, or may be a combination of positive and negative numbers to be used to add to or subtract from a baseline score. The assigned numerical scores may already reflect the weight of a security parameter within an overall scoring scheme. Alternatively, assigned numerical scores may be raw scores to be further processed in a scoring data structure and/or algorithm as described below. Preferably, the numerical scores are appropriate for the security parameter being rated. For example, the presence or absence of a particular security feature or device may sufficiently be expressed using a binary variable. Alternatively, for example, a security parameter corresponding to a number of connected devices, authorized users, or attempted unauthorized logins may be expressed more accurately as a positive integer. In an additional example, a security parameter corresponding to performance issues such as virus infection frequency may be expressed as an informative ratio, percentage or decimal as is known in the art (e.g., number of incidents per month or average response or patch time after security breach detection).

In certain embodiments, the numerical scores assigned in connection with security parameters may be explained by or understood with reference to those used in calculating an individual's FICO (Fair Isaac Corporation) score or credit score. In the calculation of a borrower's FICO score, a number of factors are considered, including age, education, length of credit history, income level, debit level, equity or asset amount, prior debt repayment history, and past delinquencies, if any. These factors reflect the person's creditworthiness or the trustworthiness of the person to repay future debts. Similarly, the security parameters reflect the trustworthiness of an information system to safeguard its data content. In calculating a FICO score, low FICO score components (indicating high risk) are assigned if a person has a low income level or a high count of past delinquencies, for example. Similarly, in information security assessment, low numerical scores (indicating high risk) may be assigned if an information system has a poor access control or has experienced several security breaches in the past. Alternatively, the inverse or complement of this type of score may be used to indicate low risk corresponding to preferred access control or past resistance to security breaches.

Similar to the identification of security parameters in step 202, the establishment of risk levels or degrees of compliance (step 208) and the assignment of numerical scores (step 210) may also be performed with reference to industry standards (step 204) and/or through consultation with regulatory bodies and their corresponding regulations or statutes (step 206).

In step 212, the security parameters, risk levels, and numerical scores may be recorded and organized into one or more data structures. One purpose of the data structures may be to properly reflect the weights of and relationship among the security parameters. Another purpose of the data structures may be to facilitate efficient scoring algorithms to be applied to the data structures. Such a data structure may be referred to as a “scoring data structure.” A typical scoring data structure may take the form of a decision tree and/or a routing table although other forms may also serve the scoring purposes.

In step 214, the scoring data structure(s) may be incorporated in a software program with a user interface and/or software/hardware interfaces. The software program may perform a core function of applying one or more scoring algorithms to the data structure(s) to calculate information security assessment (ISA) scores based on input data concerning an information system. The ISA scores may include a composite score indicative of an overall security assessment of the information system. The ISA scores may also be or comprise one or more sector scores indicative of the security assessment of certain portions or aspects of the information system. According a preferred embodiment, the ISA scores may be normalized (in the statistical sense or more general sense of transforming to the score) or confined to a predetermined range (e.g., between 300 and 850, similar to the customary FICO score range) so as to provide a convenient benchmark to compare different information systems or portions thereof.

The software program preferably has a user-friendly interface for users to input evaluation data concerning information systems, change configurations of the scoring functions, run the scoring process, and store/display/print ISA scores and other security assessment results.

The software program may also have hardware and/or software interfaces which may serve data collection functions such as system diagnosis and performance testing. That is, the software program, when properly installed in or interfaced with an information system to be tested, may automatically collect relevant data related to some security parameters. For instance, when installed in a central server of an enterprise network, the software program may automatically detect the basic configuration of the server processor, operating system version and updates, network topology, and other kinds of information. Such an auto-detect function may significantly expedite security assessment of an information system.

In step 216, the software program may be employed to assess information security of any organization. According to some embodiments, the software program may be in a stand-alone, self-contained package to be sold individually and may be installed and executed on individual computers. Alternatively, the software program may be designed to run as a Web-based service or application, wherein users may access the scoring and related functionalities remotely via standard browsers or similar user interfaces.

It should be noted that the process of identifying security parameters (steps 202-206), establishing risk levels or degrees of compliance (step 208), and assigning numerical scores (step 210) may be repeated on an ongoing or periodic basis. This is because both technological standards and legal standards for information security may evolve with time or experience significant changes. As a result, the scoring data structure(s) for information security assessment may need to be updated to reflect the changing standards. It should be recognized that the security assessment methods described herein are not locked into any particular set of technological or legal standards. Rather, the scoring data structure(s) may be constructed with capacity to grow and the software program may be built with a mechanism for frequent updates. According to one embodiment, the software program (and/or related data structures or databases) may comprise an artificial intelligence feature to learn and accumulate new security parameters and automatically incorporate them into the security assessment and scoring framework.

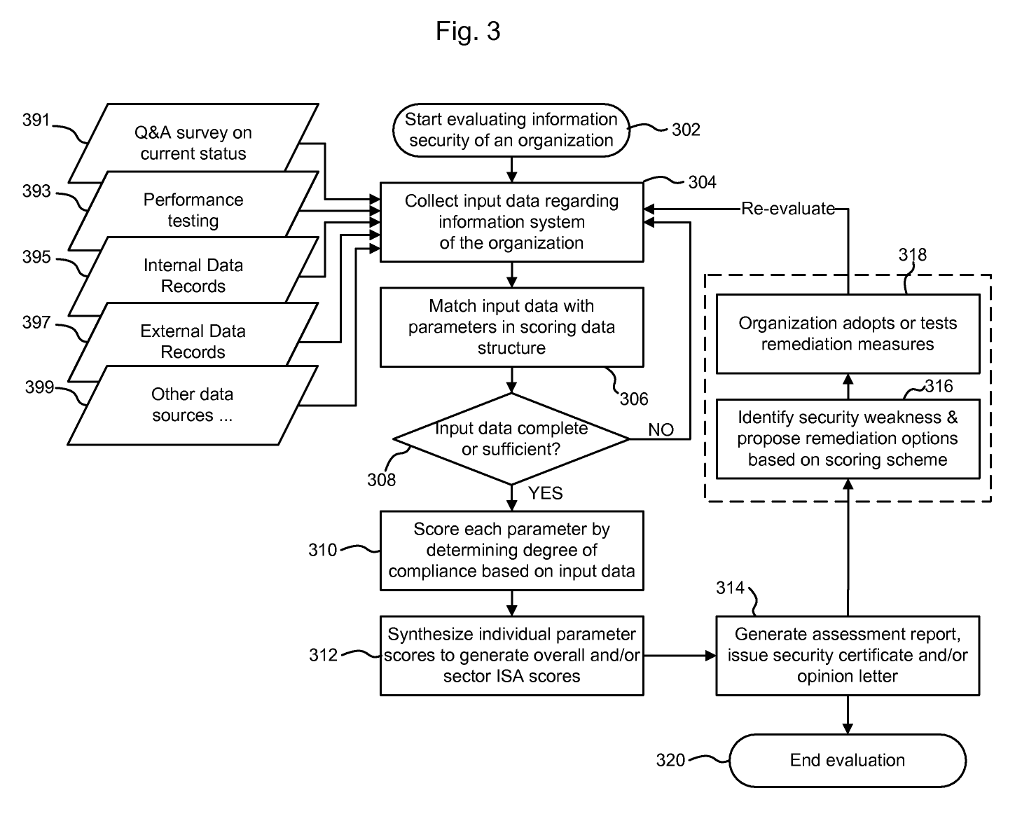

FIG. 3 illustrates a flow chart illustrating an exemplary method for information security assessment in accordance with a disclosed embodiment.

The process of evaluating information security of an organization may start in step 302. In step 304, input data regarding the information system of the organization may be collected. The input data may be collected in a number of ways and from a variety of data sources. For example, some of the input data may be collected in a conventional Q&A survey. The survey may be generated electronically based on the requirements of the particular regulatory standard being applied. A user may conduct the survey by asking questions concerning the information system and enter answers into a form or table presented through a graphical user interface (GUI). Alternatively, one or more persons familiar with the information system may be asked to complete the survey by filling in an online form. Some of the input data may be collected through an auto-detect process as described above or by conducting performance tests on the information system in question. Performance tests may be targeted at certain spots or areas that are more likely to have security weaknesses. Other sources for the input data may include internal data records maintained by the organization or external data records from third parties. Both types of data records may provide historical information on the information system in question, such as frequency and scope of prior security breaches and track records of various security measures.

In step 306, the input data collected in step 304 may be matched to security parameters in a scoring data structure. The matching may be done when the data are entered into the software program. For example, the user may be directed by the user interface to enter the input data into standardized fields which may be coded and correlated to individual security parameters. Alternatively, user inputs may be parsed to extract standard data that can be matched to known security parameters.

In step 308, it may be determined whether input data are complete or sufficient for the information security assessment to proceed. If not, the process may loop back to step 304 to continue collecting input data or to request missing data. If enough input data are available, then, in step 310, the software program may score each security parameter by determining a corresponding risk level or degree of compliance based on the relevant input data. That is, for each security parameter, the information system may receive a raw numerical score. As a result, a plurality of raw numerical scores may be established for the information system.

In step 312, the raw numerical scores may be synthesized to generate a composite ISA score for the entire information system and/or sector ISA scores for contributing sectors of the information system. The generation of the composite ISA score or the sector ISA scores may be based on one or more scoring algorithms. The scoring algorithm used may be a standard one applicable to all information systems, or the algorithm may be an industry-specific one particularly adapted or configured for certain industries. A user may be able to select which standard or specialized algorithms to apply to the input data. Also, at the front end, the user may be able to choose a standard or a specialized scoring methodology so that either a standard set or a specialized/customized set of security parameters and/or scoring data structure may be used to assess security risks of an information system.

In step 314, one or more work outputs may be generated based on the security assessment performed on the information system. The outputs may include, but are not limited to: a security report summarizing the assessment conclusion and the ISA score(s), a security certificate to show compliance with relevant security standards, and an opinion letter with more detailed evaluation and suggestions concerning security risks of the information system.

Optionally, the software program may include interactive or command-line features (step 316) to automatically identify security weaknesses in the information system of the organization and/or propose remediation options based on the security assessment and scoring results. For example, the software program may list the identified weaknesses and prioritize the remediation options for the user to choose from. The determination as to whether an organization passes or fails the security assessment, as well as the priorities of the remediation measures, may depend on the particular industry the organization is in and/or the type of activities or services supported by its information system. For instance, financial services companies, especially those involving instant movement of large amounts of funds, will have much higher security requirements (therefore higher compliance thresholds) than informational or entertainment websites such as newspapers and network radios. Accordingly, the software program may be configured to apply different compliance thresholds to information systems of different criticality and to propose different sets of remediation measures according to the importance of the information or information system protected.

In step 318, the organization may adopt or test the proposed remediation measures and re-evaluate the information system. The re-evaluation may be explicitly run for the changed set of input data. Alternatively, the re-evaluation may be implicitly run by the software program, and the remediation options may be displayed to a user in step 316 together with the corresponding changes in the ISA score(s). This way, the user may immediately recognize the potential impact each of the remediation options might have on the overall security assessment (or ISA score) and may be more motivated or prepared to make improvements on the information system. The evaluation of information security of the organization may end in step 320.

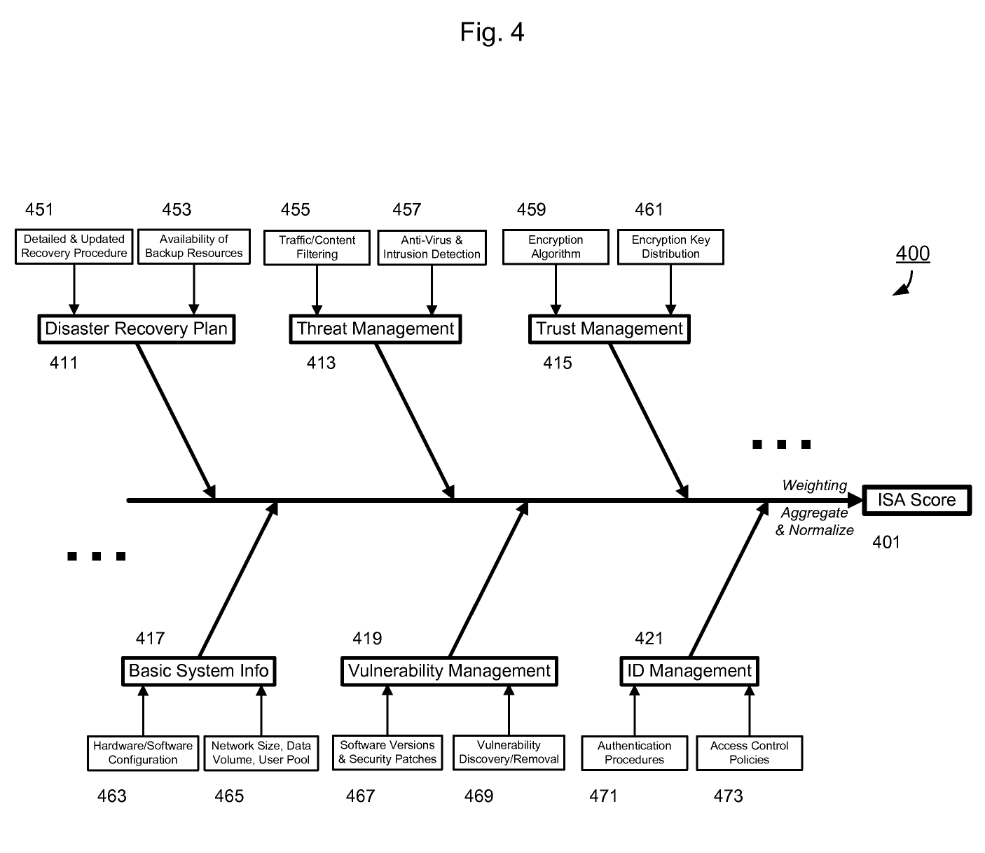

FIG. 4 illustrates a block diagram illustrating an exemplary scoring data structure 400 for information security assessment in accordance with a disclosed embodiment. The scoring data structure 400 may be conceptually divided into contributing sectors such as Basic System Information 417, Vulnerability Management 419, Identity Management 421, Trust Management 415, Threat Management 413, and Disaster Recovery 411. Other sectors or categories may also be included, and fewer sectors or categories may be provided. Each sector may be further divided into sub-categories, and the sub-categories may be divided even further or into individual security parameters. For example, the sector of Basic System Information 417 may include hardware/software configuration parameters 463, network size/scale, data volume statistics, and user pool parameters 465. The sector of Threat Management 413 may include traffic or content filtering parameters 455, anti-virus and intrusion detection parameters 457. In one embodiment, the sectors may correspond to functional groups informed by a regulation or statute. For example, the sectors may correspond to one or more of the risk-based examination topics outlined in the FFIEC Information Technology Examination Handbook: Business continuity planning, Development and acquisition, electronic banking, Fedline®, Information security, IT audit, IT management, Operations, Outsourcing technology services, Retail payment systems, Supervision of technology service providers, and Wholesale payment systems. In turn, the sub-categories and security parameters may correspond to the more detailed components outlined by such regulations and corresponding guidance booklets. For example, within the Information security, implementation of security controls may be a sub-topic, which can further be decomposed into security parameters such as network access and authentication, malicious code prevention, and encryption. In another embodiment, the sectors may correspond to physical subsets of the IT system or organization. For example, the sectors may correspond to zones 11, 12, 13 or individual components such as internal and external clients 10, 20.

Each security parameter may be evaluated and may receive a raw score for potential risk impact. This potential risk impact may correspond to an estimated expected loss corresponding to the incremental risk contributed (or mitigated) by the parameter. In turn, each of the major sectors may be evaluated and may receive a sector score based on the raw scores assigned to the security parameters within its sub-categories. Either the sector scores or the raw scores may be channeled into a trunk of the scoring data structure 400 where they may be normalized or transformed through weighting, aggregating, scaling, or otherwise processed with one or more scoring algorithms to reach a composite ISA score 401.

Table 1 illustrates a basic example of sector scores and a composite enterprise ISA reached by taking the sum of the sector scores.

TABLE 1
Regulatory & Compliance ISA Scores

| | |
|---|---|
| Audit | 90 |
| Business Continuity Planning | 75 |
| E-Banking | 80 |
| FedLine ® | 83 |
| Information Security | 85 |
| Management | 89 |
| Operations | 76 |
| Outsourcing Technology Services | 65 |
| Payments Systems | 68 |
| Enterprise ISA Score: | 711 |

The formula to generate the ISA score can take a variety of forms known in the art. A raw parameter or sector score can be scaled by a constant corresponding to the appropriate amount of security risk contributed by that parameter or sector score. Alternatively or in combination, the raw scores can be adjusted or modified to take exponential, hyperbolic, logarithmic or other non-linear form. For example, if a parameter or sector contributes particularly heavily to overall risk, the raw score might be squared or raised to another power. Additionally, if a parameter or sector's raw score contributes to risk with diminishing marginal effect, the raw score may be modified using a power or logarithmic function. The raw scores can also be confined to a predetermined range or to indicate a percentile rating or other comparison to an industry benchmark. Alternatively or in combination, the transformation or normalization of the parameter or sector score may vary based on real-time developments such as a particular virus or discovery of a particular operating system vulnerability. For example, a parameter corresponding to past or current operating system patch status may be transformed to contribute more or less to the ISA in the event a virus or other malicious code targeting a particular vulnerability is discovered.

In turn, the ISA may be a sum, average, or other function of the various raw or normalized parameter or sector scores. The ISA may itself be confined to a predetermined range, indicate a percentile rating or other comparison to an industry benchmark, or otherwise be transformed to provide an objective, informative, and industry-standard indication of the system's vulnerability or resilience. Theoretical or empirical statistical models may be utilized to optimize the ISA so that it provides a strong predictor of expected liability due to a information security breach. Models may also be applied to analyze ISA and component scores from a variety of organizations or systems to modify the calculation of the ISA to maintain its consistency across an industry and its predictive accuracy. Accordingly, the ISA advantageously provides an objective and consistent rating of risk for an organization in the context of a particular industry or set of security regulations or statutes.

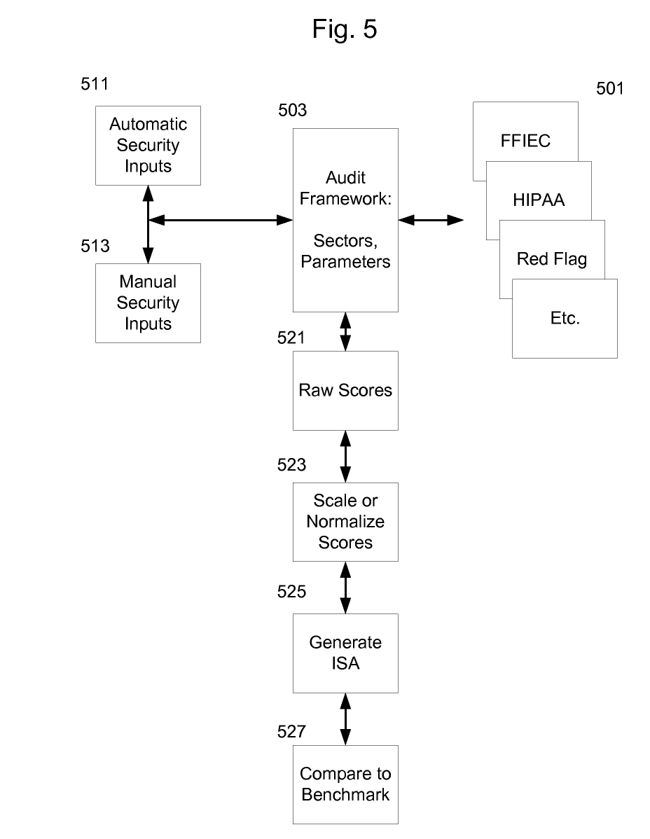

FIG. 5 illustrates a block diagram illustrating an exemplary method for information security assessment in accordance with a disclosed embodiment. Through various distributed or centralized software and hardware, automatic security inputs 511 from throughout the organization or network can be gathered. For example, update or virus scan logs may be automatically input. Hardware and software components, configurations, status, and preferences may be automatically identified or detected as well. Manual security inputs 513 include responses to electronic or other surveys from managers and decision-makers, as well as assessments directly input by a user of an exemplary software embodiment. As these surveys and the like are still are subject to errors and omissions, the inputs from the manual security inputs can be compared with results from the automatic security inputs to create a more accurate set of security data inputs. For example, a manager might erroneously respond in a survey that no viruses have been received by the system in the past month, where the virus scan logs accurately denote that one was received and quarantined. Data automatically retrieved from history logs or generated by diagnostic or monitoring software modules (centralized or distributed across the IT system) may be applied to correct or flag suspect responses contained in the manual input data set.

The security data describing the past and present security status of a system are input into an audit framework 503, which is based upon one or more relevant security regulations or statutes 501. The audit framework 503 generally dictates what security data is required to perform the security assessment. As described above, the various regulations or statutes identify various security requirements corresponding to contributing sectors and security parameters. In one embodiment, the method includes determining whether available automatic security inputs, such as historical, preferences, or properties data, satisfy the security inquiries dictated by the applied regulation or statute. In one example, if this pool of input data is not sufficient, surveys and prompts are generated to receive manual security inputs to address these portions of the security standard.

As the inputs 511, 513 are applied to the audit framework 503, raw scores 521 for the various parameters and sectors are calculated. In the various ways described above, these scores are optionally transformed, scaled or normalized 523. Based upon these scores, an ISA is generated 525. The ISA is then compared to an industry or regulatory benchmark 527 to indicate a level of compliance with information security requirements. ISAs from multiple systems or organizations within an industry can be aggregated and analyzed to fine-tune or modify the calculation of the ISA. Further, by comparing ISAs from different systems, various users and organizations can ascertain their relative level of information security and identify points of weakness for improvement or vulnerabilities to be mitigated.

While the foregoing description includes certain details, it is to be understood that these have been included only for explanation and illustration, and are not to be interpreted as limitations of the claimed embodiments. It will be apparent to those skilled in the art that other modifications to the embodiments described above can be made without departing from the spirit and scope of the claimed embodiments. Accordingly, such modifications are understood to be within the scope of the claimed embodiments.

1. A computer-implemented method for information security and data risk assessment, the method comprising:
identifying a plurality of security parameters corresponding to security aspects of the information security of an information system;
establishing at least two risk levels associated with each of the plurality of security parameters;
assigning a component score to each of the at least two risk levels associated with each of the plurality of security parameters;
storing the security parameters, risk levels and component scores in a memory according to one or more data structures, the data structures corresponding to an industry security standard; and
calculating a composite score based on the security parameters, risk levels and numerical scores, the composite score indicating the overall security risk exposure of the information system according to the industry security standard.

2. The method of claim 1, further comprising:
assessing information security collectively for an entire enterprise including at least one information system.

3. The method of claim 1, wherein the security aspects of the information system include identity management, vulnerability management, threat management, trust management, and business continuity plans.

4. The method of claim 1, wherein storing includes normalizing at least one component score.

5. The method of claim 1, wherein storing includes normalizing the composite score.

6. The method of claim 1, further comprising:
comparing the composite score against an industry benchmark to determine a difference therebetween; and
identifying at least one of the security parameters, risk levels and component scores corresponding to the difference.

7. The method of claim 1, further comprising:
calculating an industry benchmark based on a plurality of scores based upon a plurality of assessed enterprises.

8. A computer-implemented method of employing a numerical scoring scheme in an information security assessment, the method comprising:
collecting input data descriptive of an IT infrastructure of an organization;
matching the input data with a plurality of security parameters in a scoring data structure corresponding to a regulatory standard;
determining, for each security parameter and based on the input data, a component score by assessing a risk level corresponding to said each security parameter, thereby establishing a plurality of component scores; and
synthesizing the plurality of component scores to generate a composite score indicative of an overall security risk exposure of the IT infrastructure or sector scores indicative of security risks in portions or aspects of the IT infrastructure.

9. The method of claim 8, further comprising:
issuing an assessment report, a security certificate, and/or an opinion letter based at least in part on the assessment of the IT infrastructure of the organization.

10. The method of claim 8, further comprising:
identifying one or more security weaknesses in the IT infrastructure and proposing remediation options based on the assessment of the IT infrastructure of the organization.

11. The method of claim 8, further comprising:
normalizing at least one component score.

12. The method of claim 8, further comprising:
normalizing the composite score.

13. The method of claim 8, further comprising:
comparing the composite score against an industry benchmark to determine a difference therebetween; and
identifying at least one of the security parameters, risk levels and component scores corresponding to the difference.

14. The method of claim 8, further comprising:
calculating an industry benchmark based on a plurality of scores based upon a plurality of assessed enterprises.

15. The method of claim 8, wherein the regulatory standard and security parameters correspond to the FFIEC Information Technology Examination Handbook requirements.

16. The method of claim 8, wherein the regulatory standard and security parameters correspond to one of HIPAA or FTC Red Flag requirements.

17. A system, comprising:
a memory storing input data descriptive of an IT infrastructure of an organization; and
a processor configured to:
match the input data with a plurality of security parameters in a scoring data structure;
determine, for each security parameter and based on the input data, a component score by assessing a risk level corresponding to said each security parameter, thereby establishing a plurality of component scores; and
synthesize the plurality of component scores to generate a composite score indicative of an overall security risk exposure of the IT infrastructure or sector scores indicative of security risks in portions or aspects of the IT infrastructure.

18. The system of claim 17, wherein the processor is further configured to normalize at least one of the component scores or the composite scores.

19. The system of claim 17, further comprising:
a database storing a plurality of composite scores for a plurality of organizations, wherein the processor is further configured to construct an industry benchmark for the plurality of organizations based on the plurality of composite scores.

20. The system of claim 17, wherein the processor is further configured to compare the composite score against an industry benchmark to determine a difference therebetween, and to identify at least one of the security parameters, risk levels and component scores corresponding to the difference.
